(19) United States
(12) Patent Application Publication
(10) Pub. No.: US 2012/0096344 A1
(43) Pub. Date: Apr. 19, 2012

(54) RENDERING OR RESIZING OF TEXT AND IMAGES FOR DISPLAY ON MOBILE / SMALL SCREEN DEVICES

(75) Inventors: Ronald Ho, Fremont, CA (US); Andrew A. Grieve, Waterloo (CA)

(73) Assignee: GOOGLE INC., Mountain View, CA (US)

(21) Appl. No.: 12/907,661

(22) Filed: Oct. 19, 2010

(51) Int. Cl. G06F 17/00

(52) U.S. Cl. 715/249

(57) ABSTRACT

Various embodiments are disclosed. According to one example embodiment, an apparatus may include at least one processor; at least one memory including computer program code, the at least one memory and the computer program code configured to, with the at least one processor cause the apparatus to at least: receive, by a computing device having a display with a first dimension that is less than a threshold size, a document including text and at least one image; reformat the document for display on the computing device, including: decreasing a size for at least one of tabs or indents; and moving a location of the at least one image to the left on the display of the computing device.

### TECHNICAL FIELD

This description relates to the rendering or resizing of text and images for display on mobile computing devices/small screen devices.

### BACKGROUND

There are a wide variety of electronic or computing devices that may communicate electronically, such as through a network, e.g., wireless network, Internet or other network. These computing devices may come in a variety of sizes. Some of these devices may have a full-size screen, such as a desktop computer or a laptop. Mobile computing devices (or simply mobile devices), such as cell phones, PDAs (personal digital assistants), and other handheld or highly portable computing devices may typically have a screen size that is smaller than a full-size screen offered by most desktop and laptop computers. Problems may arise when attempting to display text, images and other information on a mobile device or other small-screen device that was formatted for display on a full-size (or larger) screen device.

### SUMMARY

In a general aspect, an apparatus includes at least one processor and at least one memory that includes computer program code. The computer program code is configured to, with the at least one processor, cause the apparatus to receive, by a computing device that has a display with a first dimension that is less than a threshold, a document that includes text and at least one image. The apparatus is further caused to reformat the document for display on the computing device, where the reformatting includes decreasing a size for at least one of tabs or indents and moving a location of the at least one image to the left on the display of the computing device.

According to another general aspect, a method includes receiving, by a computing device that has a display with a first dimension that is less than a threshold, a document including text and at least one image, and formatting the document into a small-size display format for display on the computing device. The formatting includes including decreasing a size for at least one of tabs or indents from a first size to a second size and moving a location of the at least one image from a first location to a second location. The second location is located to the left of the first location on the display of the computing device. The formatted document is displayed in the small-size format on the computing device.

According to another general aspect, a method include receiving, by a computing device that has a display with a first dimension that is less than a threshold size, a document that includes text and at least one image. The document is formatted into a small-size display format for display on the computing device, where the formatting includes decreasing a font size of any text in the document that is greater than the maximum font size to the maximum font size and moving a location of the at least one image from a first location to a second location, where the second location is located to the left of the first location on the display of the computing device.

According to another general aspect, a method includes transmitting, from a computing device to a server, a first request for a document, where the request includes a user agent field that indicates the computing device is a first type of user agent. At least a portion of the requested document is received in a first display format based on the user agent field indicating a first type of user agent. The received portion of the received document is displayed, on the computing device, in the first display format. A request to view at least a portion of the document in a second display format is received at the computing device via user input. A second request for the document is transmitted from the computing device to the server, where the second request includes a user agent field that indicates that the computing device is a second type of user agent. At least a portion of the requested document is received in a second display format based on the user agent field indicating a second type of user agent. The received portion of the received document is displayed on the computing device in the second display format.

According to another general aspect, an apparatus includes at least one processor and at least one memory that includes computer program code. The memory and the computer program code are configured to, with the at least one processor cause the apparatus to transmit, from a computing device to a server, a first request for a document, where the first request includes a user agent field that indicates the computing device is a first type of user agent. The apparatus is further caused to receive at least a portion of the requested document in a first display format based on the user agent field indicating a first type of user agent and to display, on the computing device, the received portion of the received document in the first display format. The apparatus is further caused to receive, at the computing device, based on user input, a request to view at least a portion of the document in a second display format and to transmit, from the computing device to the server, a second request for the document, where the second request includes a user agent field that indicates that the computing device is a second type of user agent. The apparatus is further caused to receive at least a portion of the requested document in a second display format based on the user agent field indicating a second type of user agent and to display on the computing device the received portion of the received document in the second display format.

According to another general aspect, a method includes transmitting, from a computing device to a server, a request for a first document, the request for the first document including a user agent field that indicates the computing device has a first size display. At least a portion of the requested first document is received in a first display format based on the user agent field indicating a computing device with a first size display. A request for a second document is transmitted from the computing device to the server, where the request for the second document includes a user agent field that indicates the computing device has a second display that is larger than the first size display. At least a portion of the requested second document is received in a second display format based on the user agent field indicating a computing device that has a second size display.

According to another general aspect, an apparatus may include at least one processor and at least one memory that includes computer program code. The memory and the computer program code are configured to, with the at least one processor, cause the apparatus to transmit, from a computing device to a server, a request for a first document, where the request includes a user agent field that indicates the computing device has a first size display. The apparatus is caused to receive at least a portion of the requested first document in a first display format based on the user agent field indicating a computing device with a first size display and to transmit from the computing device to the server a request for a second document, where the request for the second document includes a user agent field that indicates the computing device has a second display that is larger than the first size display. The apparatus is caused to receive at least a portion of the requested second document in a second display format based on the user agent field that indicates a computing device that has a second size display.

According to another general aspect, a method includes receiving a request for a document that includes an image from a mobile computing device. A display size of the mobile computing device is determined, where the display size includes a first dimension and a second dimension. Whether or not a width of the image is greater than a larger of the two dimensions of the display size of the mobile computing device is determined, and if the width is greater than a larger of the two dimensions of the display size a size of the image is reduced so that the width of the image is equal to or less than the larger of the two dimensions of the display size. The document including the reduced image is transmitted to the mobile computing device.

According to another general aspect, an apparatus includes at least one processor and at least one memory that includes computer program code. The memory and the computer program code are configured to, with the at least one processor, cause the apparatus to receive a request for a document that includes an image from a mobile computing device and to determine a display size of the mobile computing device, where the display size includes a first dimension and a second dimension. Whether or not a width of the image is greater than a larger of the two dimensions of the display size of the mobile computing device is determined, and if the width is greater than a larger of the two dimensions of the display size a size of the image is reduced so that the width of the image is equal to or less than the larger of the two dimensions of the display size. The document with the reduced image is transmitted to the mobile computing device.

According to another general aspect, a method includes sending a request for an image from a mobile computing device that has a display with a first dimension and a second dimension, where at least one of the first dimension or the second dimension are less than a threshold dimension. A reduced version of the requested image is received by the mobile computing device, where a width of the received reduced version of the requested image is equal to or less than the larger of the two dimensions of the display. The reduced version of the image is displayed on the display of the computing device in a first display mode, and the following are performed in a second display mode: further reducing a size of the reduced version of the image to provide a further reduced version of the image, where a width of the further reduced version of the image is equal to or less than a smaller of the two dimensions of the display; and displaying the further reduced version of the image on the display.

According to another general aspect, a computer program product that is tangibly embodied on a computer-readable medium includes executable code. When executed, the code causes one or more processors of a computing device to send a request for an image from the computing device. The computing device has a display with a first dimension and a second dimension, where at least one of the dimensions is less than a threshold dimension. Execution of the code causes a reduced version of the requested image to be received by the computing device, where a width of the received reduced version of the requested image is equal to or less than the larger of the two dimensions of the display and to display the reduced version of the image on the display of the computing device in a first display mode. Execution of the code causes the following to be performed in a second display mode: (1) further reducing a size of the reduced version of the image to provide a further reduced version of the image, where a width of the further reduced version of the image is equal to or less than a smaller of the two dimensions of the display; and (2) display the further reduced version of the image on the display.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system according to an example embodiment.

FIG. 2 is a diagram illustrating the selection and display of a portion of a document in a full-size display mode according to an example embodiment.

FIG. 3 is a diagram illustrating the reduction of an image size for display on a small-size display according to an example embodiment.

FIG. 4 is a diagram illustrating a further reduction in image (or object) size according to an example embodiment.

FIG. 5 is a diagram illustrating a reformatting of a document according to an example embodiment.

FIG. 6 is a flow chart illustrating operation of a computing device according to an example embodiment.

FIG. 7 is a flow chart illustrating operation of a mobile computing device according to an example embodiment.

FIG. 8 is a flow chart illustrating operation of a computing device according to an example embodiment.

FIG. 9 is a flow chart illustrating operation of a mobile computing device according to an example embodiment.

FIG. 10 is a flow chart illustrating operation according to an example embodiment.

FIG. 11 is a flow chart illustrating operation according to an example embodiment.

FIG. 12 is a block diagram showing example or representative structure, devices and associated elements that may be used to implement the computing devices and systems described herein.

### DETAILED DESCRIPTION

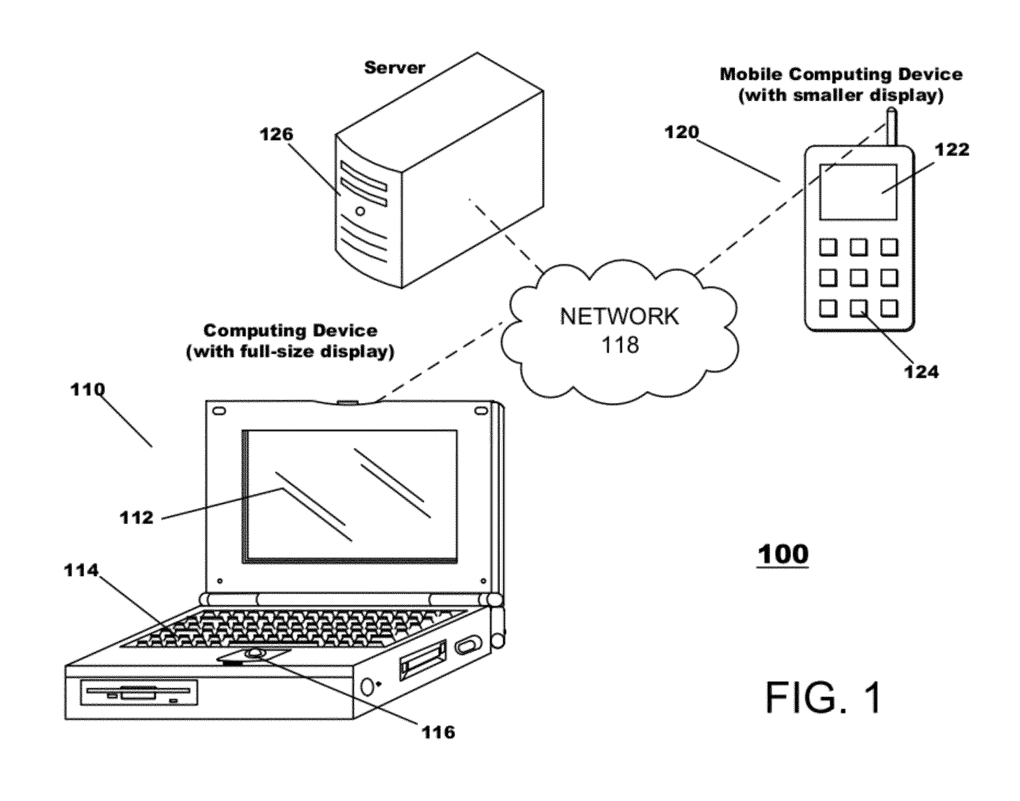

FIG. 1 is a block diagram of a system according to an example embodiment. System 100 may include a variety of computing devices connected via a network 118. Network 118 may be the Internet, a Local Area Network (LAN), a wireless network (such as a wireless LAN or WLAN), or other network, or a combination of networks. System 100 may include a server 126, and one or more computing devices, such as a computing device 110, and a mobile computing device 120. System 100 may include other devices, as these are merely some examples.

Server 126 may receive and store documents or information, and may allow other computing devices to store and retrieve documents or information thereon. Server 126 may include a processor for executing software, a memory, and a network interface, for example.

A document may include a collection of data or information. The document may be provided in an electronic form, and may include different kinds of data, including, for example, text, images, equations, charts, tables, etc., and may include formatting or control information, a computer program or software code such as a Java script or other code/program. One example document may include a Web page or Web document, such as, for example, a HTML (Hyper-Text Markup Language) document/page, which may include text, images and other information, and may include a program therewith (e.g., embedded in the document) that indicates or provides a display format for displaying the data or information of the HTML page/document. A Web page and/or HTML page/document are merely examples of a document, and many other types of documents may be used.

Computing device 110 may be a laptop 110 having a full-size display 112, a keyboard 114, a pointing device 116 (such as a track ball, mouse, touch pad or other pointing device). Display 112 may be considered full-size since it is sufficient height and width, e.g., to allow documents to be displayed without excessive horizontal scrolling or without reformatting documents. A full-size display may include a number of different display sizes and types, such as displays that are commonly found on laptops, and used with desktop computers, as examples. In an example embodiment, a computing device that includes a full-size display may be referred to as a full-size computing device. A full-size display may include two dimensions, e.g., height and width. In an example embodiment, a full-size display may be a display in which at least one of these dimensions is greater than a threshold, e.g., a displaying having a width larger than X inches, or greater than Y pixels, e.g., having a width greater than 450 pixels, as an example. These are merely some examples. A full-size display may include a variety of different display sizes and may, for example, be larger than a threshold size, as noted, according to an example embodiment. Alternatively, a full-size display may include displays having a surface area (height×width of the display) that is greater than a threshold size.

In an example embodiment, display 112 may be a touch-sensitive display or touchscreen that can detect the presence and location of a touch within the display area. The touchscreen may be touched with a hand, finger or stylus or other object. A touchscreen may allow a user to interact directly with what is displayed by touching the screen, rather than interact indirectly by controlling a cursor using a mouse or touchpad.

Mobile computing device 120 may be a cell phone, PDA, a wireless handheld device, or any other handheld or portable computing device. Computing device 120 may include a display 122, a keypad 124. Display 122 may be any type of display, and in one example embodiment, may be a touch-sensitive display or touchscreen in which a user may directly interact with what is displayed by touching the screen or display with a finger, hand, stylus, etc. The display 122 of mobile computing device is typically smaller than full-size display 112, and therefore, display 122 may be referred to as a small-size display since it is smaller than a full-size display. The small-size display may include, for example, displays that are smaller than a threshold, e.g., a display having a width that is less than P inches, or less than Q pixels, e.g., a display wherein a smaller dimension (e.g., width of the display), is less than 450 pixels, for example. This is merely an example, and the embodiments are not limited thereto. Or having a width less than a first threshold and/or a height less than a second threshold, for example. Alternatively, a small-size display may include displays having a surface area (height×width of the display) that is smaller than a threshold size. These are merely some examples, as a small-size display may be a display that is smaller than a typical full-size display.

Although not shown in FIG. 1, mobile computing device 120 may include a processor for executing software or instructions, a memory for storing instructions and other information, input/output devices, and an accelerometer to detect motion or movement of the computing device.

According to an example embodiment, a document (which may include text, images, and other objects) may be created and stored on a server 126, for example. The document may be formatted for display on a full-size display 112. Mobile computing device 120 may send a request message requesting a copy of the document (e.g., as a HTTP or Hypertext Transfer Protocol Get message or other request). Mobile computing device 120 may receive and display the document on small-size display 122. In an example embodiment, a document originally formatted or a full-size display may be received for displaying on a mobile computing device with a small-size display, e.g., the small-size display having at least one display dimension that is less than a threshold. In an example embodiment, the document may be reformatted (e.g., by either a server or the mobile computing device) for display on the small-size display of the mobile computing device, e.g., to provide ease of viewing (or improved viewing). In an example embodiment, a user of the mobile computing device may toggle or switch between different display modes, such as a small-size display format of the document and the full-size display format for the document.

In an example embodiment, prior to displaying the document, the mobile computing device 120 may format (or reformat) the document for display or rendering on the small-size display 122 of the mobile computing device 120, e.g., to better display the document given the smaller size of the small-size display 122, if the received document is not already in a small-size display format. Formatting or reformatting of a received document may be triggered by a number of different situations or factors, such as, for example: 1) all documents may be reformatted; 2) a format code may be provided in the document itself or in received message (e.g., in a header or other field) from a server that identifies the format of the provided document (e.g., a format code or an identifier indicating small-size display format, or indicating full-size display format), and the receiving mobile computing device may reformat the document if the document is not in a desired or requested format, for example; 3) the receiving computing device may analyze the document to determine that the document is in a first format (e.g., full-size display format), and thus may convert the document to a desired or requested second format (e.g., small-size display format); or 4) a server may detect a display size or screen size of a requesting computing device, or the type of computing device, e.g., based on a user agent string provided by the requesting computing device, and the server may for example, reformat the requested document (prior to sending the document to the computing device) from a standard or full-size display format to a small-size display format if the display size of the requesting computing device has a dimension (e.g., width or height) that is less than a threshold or if the computing device is classified as a mobile computing device (or small-size display device), for example.

These are merely some examples. In example embodiments, either the receiving computing device (that requests and/or receives the document) or the server that provides or transmits the document to the computing device may reformat the document from a first display format to a second display format. In an example embodiment, a document may be initially in a full-size display format and may be converted or reformatted (e.g., either by the server that provides the document to the computing device or by the receiving computing device) to a small-size display format. In other example embodiments, a document may be provided (or may initially exist) in a small-size display format, and the receiving computing device (or the server that provides the requested document) may convert the document to a full-size display format. Further details will now be provided for these (and other) examples in which reformatting of a document may be triggered or caused to occur.

As noted, in an example embodiment, received documents (which may be in a first format, e.g., a full-size display format or in a format to be displayed on a first or full-size display) may be reformatted from a first display format to a second display format. For example, a document may be reformatted if the document is not in a second format, such as a small-size display format or in a format to be displayed on a second, smaller-size display or screen size. A document, e.g., a web page or other document, may include some information (e.g., a format code or format identifier) that indicates a display format for the document. For example, the document may include information that indicates a full-size version or that the document is a full-size version of the document or provided in a full-size display format, e.g., the document is designed to be displayed on a full-size display or to be displayed on a display/screen having at least one dimension greater than a threshold, for example. Or the received document may include information that indicates it is provided in a small-size display format or in a format that may be designed to be displayed on (or having a format that accommodates) a mobile computing device display or a display having at least one dimension that is less than a threshold, e.g., a mobile version (or small-size display version) of the webpage or document. In an example embodiment, the mobile computing device may reformat the document to a small-size display format if the document indicates it is provided in a full-size (or non small-size) display format.

In another example embodiment, a format of a document may be analyzed (e.g., either by a server providing the document prior to sending the requested document or by a mobile computing device after receiving the document) to determine a format of the document, e.g., whether the document is provided in a first display format (e.g., full-size display format) or a second display format (e.g., a small-size or mobile device display format). If the document is not in the desired or requested format, then the document may be reformatted to the correct format, for example. By way of example, a server or computing device may determine a format of a document by analyzing or evaluating one or more format-related aspects or criteria of the document, such as: determining if an image(s) in the document are too large (or an image having a size or at least one dimension that is greater than a threshold), if text in the document uses a font size that is greater than a threshold, margins that are greater than a threshold, tabs or indents are greater than a threshold, or other formatting information for the document indicates a full-size format, or that steps should be taken to place the document in a small-size format that may be more effectively displayed on a small-size display.

For example, formatting changes/edits may be made to the document to decrease horizontal scrolling by a user when viewing the document. Mobile computing devices typically may have a display or screen size that is narrower than a full-size display. Thus, to view the information on a full-size page, a user may be required to perform significant horizontal scrolling (e.g., scrolling to the right). Thus, in at least some cases, information of a document (e.g., images, text, and the like) may be reformatted to allow more of this information to be seen on a mobile device or small-size display, e.g., with less horizontal scrolling by the user. This reformatting of a document for a small-size display may include, for example, reducing margins (to allow more information to be displayed), reducing indents or tabs, reducing or capping font size, reducing images, or moving location of an image, etc. In an example embodiment, this reformatting of the document (or rendering techniques) may be used to change how the document appears locally, e.g., to better display the document on small-size display 122. When such reformatting is done by the computing device for local display purposes, this reformatting may not change the substance of the document nor change the copy of the document as stored in server 126, but may be used for local rendering/display of the document on mobile computing device 120, according to an example embodiment. Alternatively, the server may also reformat the document prior to sending the document to the computing device. This reformatting by a server may include the server generating a second version of the document that provides the format (or formatting information) for the small-size display format, for example. These are merely some examples.

Mobile computing device 120 and/or server 126 may make a number of formatting changes to the document to reformat the document for improved display on a small-size display, such as, describe in the examples below.

### a) Decreasing a Size of Tabs and Indents.

In one example, tabs and indents may be decreased to a fixed size, e.g., where the fixed size may be based on a width of the small-size display 122 (e.g., smaller the width of display 122, then a smaller tab or indent size may be used). Alternatively, tabs (or tab stops) and indents may be decreased or reduced in size/width by using a partial indent. Rather than use the full-size indent (e.g., the indent used for a document displayed on a full-size display or screen), a relative indent may be used where the full-size indent or tab stops may be divided by a selected number, e.g., divided by 2 to provide a smaller indent size for mobile computing devices. Tabs and indents may be provided as a number of points, and the size of the tabs or indents may be reduced or decreased, e.g., by reducing or decreasing the size of the indents and/or tabs to a fixed size or by dividing the size (e.g., in points) of the current tabs or indents by a fixed number, e.g., 2, as an example. Other techniques may be used to decrease a size of tabs or indents. For example, tabs and indents may be eliminated (reduced to zero), for example, for the small-size display format. In another example embodiment, a first tab size or indent size may be used for a first range of display sizes (or a first set of computing devices), and a second tab size or indent size may be used for a second range of display sizes or a second set of computing devices (e.g., where a slightly larger tab/indent may be used for a set of displays that are larger, for example. The number used to divide the current tab or indent size by, or the size of the new reduced indents/tabs may be stored in a database or stored in memory of the mobile computing device, for example.

### b) Capping (or Limiting) Font Size

In another example, a font size for the text in a document may capped at (or limited to) a maximum font size. Different techniques may be used to limit or cap the font size of text in a document. In one example embodiment, a maximum font size (e.g., 36 point) may be stored in memory, e.g., text size will be allowed up to 36 point (larger font sizes in the document will be displayed at 36 point—thus, capped at or limited to 36 point, in this example). Alternatively, the font size of some text may be reduced, e.g., reduce all text above 30 point by 10 points. Note, that the mobile user can still perform document editing, and may select a font size larger than the capped font size, but the text will merely be displayed on the mobile small-size display up to the capped size, due to limited display size, for example. Various techniques may be used to cap (or limit) the font size of text in the document to a maximum font size for display on a mobile computing device/small-size display. For example, a maximum font size to be used for displaying the document text on the mobile computing device can be determined, any text in the document that has a font size that is greater than the maximum font size can be identified, and the font size of the identified text can be decreased to the maximum font size.

In one example embodiment, the mobile computing device may store a database or table that indicates a maximum font size (e.g., 36 point), where text greater than this font size is reduced to 36 point. In some cases, different mobile computing devices, with different display sizes, may use different maximum font sizes. For example, a maximum font size may be assigned by a server (or other entity) to a mobile computing device, or the mobile computing device (or a user thereof) may select a maximum font size, e.g., based on the display size of the computing device. In another example embodiment, a set of reduced font sizes for a number of possible fonts, e.g., 48+ pt. −>36 pt., 40-47 pt. −>34 pt., 36-39 pt. −>30 pt., (where −> means reduce to) and no reduction below 36 pt., according to a simple example, where text may be reduced to a new font size depending on the current font size for each character, e.g., based on a font size map or table stored in memory of the mobile computing device, for example.

### c) Moving an Image, Block or Object to Left Side of Display.

In another example, an object (e.g., image, equation, chart or table) may be centered in the document, or placed on the right side of the document in full-size (or standard) format. In an example embodiment, the position of the object may be moved to the left (e.g., far left) side of the display. This may decrease the amount of horizontal scrolling to view the document on a mobile computing device or small-size display, as compared to the horizontal scrolling required to view the original (or full-size display format where image has not been moved) document on the small-size display. Thus, an image may be moved to the left, which may include decreasing a distance between a left margin and a left edge of the image, or left justifying the image on the document so that the image is moved to the left side (or more towards the left edge) of the document. By moving the image, horizontal scrolling required to view the document may be decreased (since the image may typically be more visible with less scrolling to the right) as compared to viewing the document where no such image movement has occurred.

### d) Reflow the Text, Based on a Difference in Display Size

In another example, reflowing of text (and images or other objects) may include changing or modifying the location (or relative location) of characters (or objects) on a display or screen based on a change in display size. For example, text that may appear on one line in full-size format may be wrapped around at the small-size display border (or right hand edge of the display) and may appear on multiple lines of the small-size display, for example.

### e) Rendering Simplifications

In another example, different techniques may be used to simplify the display or rendering of a document. For example, margins can be decreased or even removed (e.g., removing a margin may include decreasing the margin to 0 inches, for example). Leading tabs or indents can be decreased or removed. All in-line tabs can be reduced to spaces or partial-sized tabs (e.g., as discussed above), or tabs can be removed in some cases. For example, performing one or more of these techniques (e.g., decrease or remove tabs, indents, margins) may include fitting or squeezing more text/information in a limited space or small-size display). In addition, all embedded objects (e.g., equations, images, tables) can be shown without text wrapping (for example), or some types of embedded objects can be replaced with icons, e.g., equations, charts, tables.

In an example embodiment, in order to maintain the original formatting when viewing or editing a document in the small-size display format, edits may be made using operational transformations, in which the edit to a document may be undone by performing the reverse transformation. For example, one operational transformation on a document may include decreasing all left and right margins from ½″ (or x points) to 0, which removes the margins, for a better display on a small-size display. This edit may be undone or reversed by performing a reverse transformation, e.g., increasing the left and right margins back to ½″ or x points, for example. Similarly, other operational transformations may be performed, e.g., to decrease or remove tabs, indents, or other edits, and reverse transformations (e.g., increase the tabs or indents back to their original size for the document) may be performed to place the document back in its original form. For example, this may allow a mobile computing device to locally store (at least initially) only one copy of a document, while allowing a display of the document in two display formats, e.g., original or full-size display format, and a small-size display format that may be obtained after performing one or more operational transformations, for example. These are merely some examples and many other operational transformations may be used. Similarly, these same formatting or transformations may be performed on the server 126 prior to sending the requested document. The server may perform the transformations or reformatting of the document (e.g., from a full-size display format to a small-size display format), e.g., in response to a user agent string or other information from the requesting computing device that indicates that the requesting device is a mobile computing device or a device having a display or screen with a size or dimension that is less than a threshold. Alternatively, some edits or reformatting or transformations may be performed on the server and other edits or reformatting or transformations may be performed on the computing device.

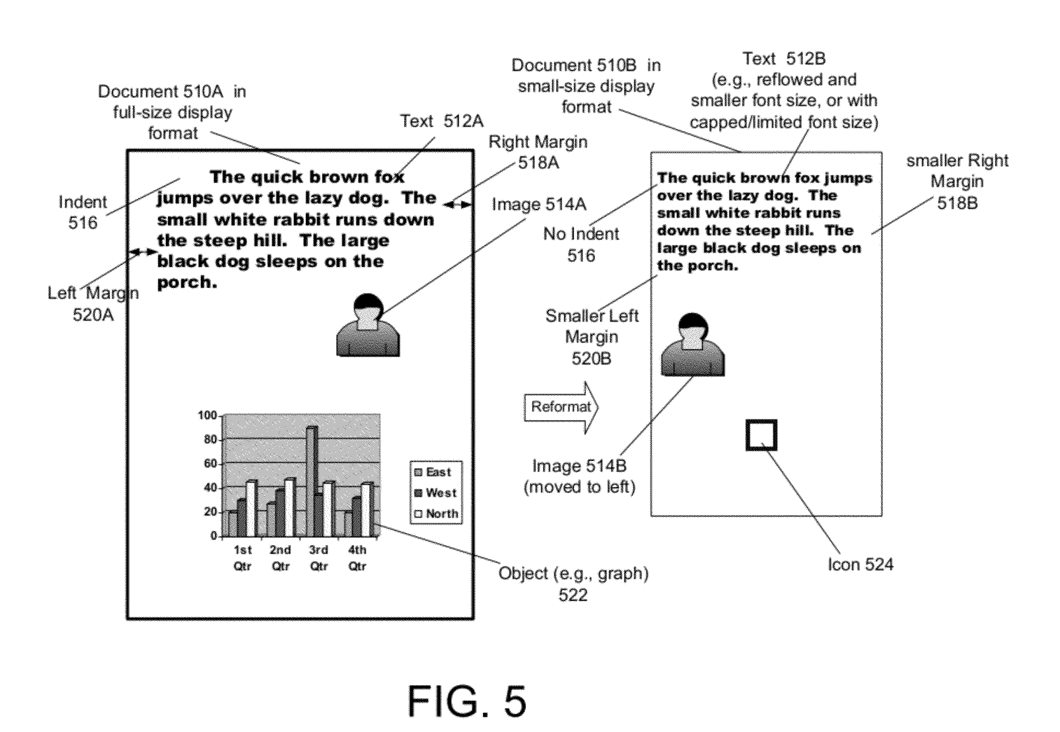

FIG. 5 is a diagram illustrating a reformatting of a document according to an example embodiment. Document 510A may be provided in a first format, such as a full-size format in this example. The document may include text 512A that includes a paragraph with a first tab or indent 516, a left margin 520A of 20 points (for example), a right margin 518A of 20 points, and an (embedded) object, such as a graph 522. A mobile computing device (or server, or other computing device) may perform one or more operational transformations (or document modifications) to reformat document 510A to a document 510B provided in a second format such as a small-size format, for example. Document 510B may include text 512B that has a smaller font size (10 pt. here, vs. 12 pt. for document 510A), or a font size has been capped or limited for text in document 510B. Also, in document 510B, text has been reflowed based on a smaller size screen (e.g., location of words have been adjusted based on smaller screen size). For example, the word “down” now shows up on the fourth line instead of the third line. Thus, the text has been reflowed from the third line to the fourth line, for example, to accommodate a smaller display width, for example. Indent 516 in document 510A has been decreased, or removed as shown in document 510B. The left margin 520B and right margin 518B are smaller (e.g., 4 pts.) as compared to the right margin 520A and left margin 518A (e.g., 20 pts.) of document 510A, to allow more text to be provided within a fixed space. Also, image 514A has been moved to the left as moved image 514B, e.g., to decrease the amount of horizontal scrolling, which may allow the image 514B to be seen with no scrolling or at least less horizontal scrolling after being moved to the left. An object or embedded object, such as graph 522 may be replaced with an icon 524 (or simple representation) to represent the presence in the document of a more complex object 522, e.g., to reduce an amount of space required on the display for the object/icon, and to reduce amount of memory required to store the document 510B. In one example embodiment, a user may click or select the icon 524 to view and/or edit the corresponding object 522, for example.

According to an example embodiment, a user of a mobile computing device may be viewing a document in a small-size format. The user may be interested in how that document may appear or look when viewed in full-size format. Therefore, according to an example embodiment, a user may select a portion of a document (e.g., a portion of text or other objects), and then the user may select “full-size display format,” e.g., by clicking or selecting a magnifying glass icon on the menu (or other icon, command or input). When this command is selected, the mobile computing device may switch or toggle to a full-size display format. This may cause the mobile computing device 120 to display a portion of the document, e.g., by magnifying or blowing up a portion of the document. While less of the document may be viewed in such a full-size display format, it may provide the user a view of what the portion of the document may look like when viewed by a full-size computing device (viewing in full-size display format), e.g., laptop, desktop or other computer having a full-size display, for example. Thus, a mobile computing device may receive and display a document in a small-size display format. In response to the user selection to view the document in a full-size format, the computing device may send a request for the document in full-size display format, or may request a portion of the document in a full-size display format. The computing device may then receive and display the requested portion (e.g., page) of the document in a full-size display format. The user may use an icon, command or other input to toggle the display between displaying the document in small-size display format and displaying (at least a portion of) the document in a full-size display format.

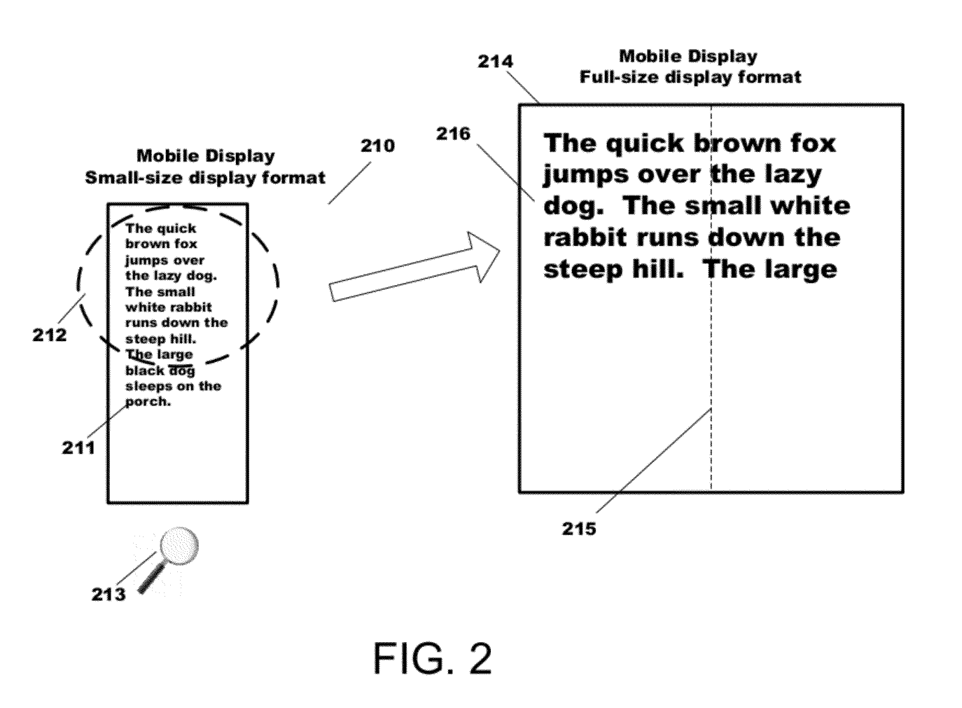

FIG. 2 is a diagram illustrating the selection and display of a portion of a document in a full-size display mode according to an example embodiment. A mobile (or small-size) display 210 may be provided on a mobile computing device 120.

The document may be created and stored in a server 126, e.g., in a standard or full-size display format. The mobile computing device 120 may send a message to server 126 via network 118 to request (a copy of) the document, for example, such as via a HTTP Get message, or the other request. After receiving the document, the mobile computing device 120 may, for example, reformat the document (or at least a portion thereof) from the full-size display format to a small-size display format, if necessary. Alternatively, the server, upon receiving the request, may reformat the stored document from a first format to a second format (e.g., from a full-size display format to a small-size display format), and then send the document to the computing device, where the second format may be associated with a user agent string received from the computing device. For example, a user agent string (e.g., provided in a header of the document request) may indicate that the requesting computing device is a mobile computing device (e.g., based on an identified computing device or type of device, a type of Operating System, and/or a type of web browser, as examples). The document 211 (FIG. 2) may then be displayed in small-size display format on the small-size display 122/210 (FIG. 2) of the mobile computing device 120, for example. In FIG. 2, a document 211 may be displayed in a small-size format on display 210 of a mobile computing device.

The mobile computing device 120 may determine that the received document is either in a full-size display format or a small-size display format using a number of different techniques. Alternatively, in response to receiving a request for a document in a mall-size display format, the server may determine that the document is stored in a full-size display format (and thus, may need to be converted to a small-size display format). For example, a field or value provided in the received document may identify the document as either full-size display format or small-size/mobile display format, for example. Also, in the absence of a field or value indicating small-size or mobile display format for the document, the mobile computing device 120 may assume that the document is provided in a full-size display format. Alternatively, in another embodiment, the document request sent to the server may include a user agent string, which may identify one or more of an operating system (OS), web browser and/or device type. If the document request includes a user agent string that identifies an OS (e.g., mobile OS) or web browser (e.g., mobile or mini web browser) typically associated with a mobile computing device/device having a small size display, or if the user agent string identifies a mobile computing device (or device having a small-size display), then the device may assume that the document being received (in response to the request) is in a small-size format. Otherwise, if the user agent string identifies an OS, web browser and/or device type typically associated with a full-size device or display, or if no user agent string is provided, then the requesting device may assume that the received document is in a full-size display format. Alternatively, a computing device may directly analyze the received document, e.g., by measuring margins, font sizes, size or presence of indents or tabs, size of images, and other formatting of the document, to determine the format for the received document, for example. A number of different control inputs may be used to cause the computing device to switch or toggle between displaying the document in two different display formats. For example, a user may select an icon (e.g., a magnifying glass) to toggle between full-size display format and small-size display format for a document. Alternatively, a user may use one or more gestures to toggle between two different display formats, e.g., thus may shake the mobile device once for a first format, and may shake the mobile device twice for a second format, or may tap the display for a first format and twist the device for a second format. Audio or voice or speech commands may be used to cause or trigger the device to toggle between a first format and a second format. Referring to FIG. 2 again, the user may then select or may identify (e.g., via finger touch on touchscreen, or via mouse or touch pad input) a point on the document (or may otherwise identify a portion of the document), represented as circle 212, for example. The user may then click on or select, for example, a magnifying glass icon 213 (or other button/command) on the menu which may indicate a request to view the portion/document in full-size display format (e.g., to magnify the display of the document). The mobile computing device 120 may then switch or toggle to a full-size display format, shown as display 214, illustrating a portion 216 of the document in a full-size display format. (Displays 210 and 214 are the same displays, only the format of the displayed data is different).

In an example embodiment, to toggle or switch to a full-size display format (or display a portion of the document in full-size display format), mobile computing device 120 may first download the selected portion of the document in full-size display format from server 126, if not already stored in local memory. Line 215 may represent the boundary or end of the actual small-size display. Thus, the user of a mobile computing device (with a small-size display), while viewing a document in full-size display format, may only be able to see either the left half or the right half of portion 216, and may need to perform horizontal scrolling left and right to view the right and left hand sides of document/portion 216. This may be because, in full-size display format for the displayed portion 216, the text may be a larger font, tabs and indents may be longer, full-size display format margins may be used, text may not be reflowed or rewrapped given the small width of a small-size display, and other full-size display format may take up more space on the display or require more horizontal scrolling, for example, as compared to a small-size display format.

After viewing and/or editing the document in a full-size display format, a user input (e.g., gestures, keystrokes, selecting icons such as pressing or selecting the magnifying glass or other icon, command or button)) can cause the display format to switch or toggle back to small-size display format, shown at display 210. In full-size display format of display 214, the portion of the document may be a view (or read) only format, or may be fully editable.

Thus, for example, a user may toggle or switch back and forth between viewing a document or image (or other object) in either full-size display format or small-size display format. For example, while a computing device with a full-size display may normally display a document using full-size display format, a user may toggle or switch the display format to small-size display format to see how the document being edited may be displayed on a mobile computing device with a small-size display. Similarly, while a mobile computing device may typically display a document in small-size display format (e.g., to decrease or minimize horizontal scrolling on the small-size display), a user of the mobile computing device may decide to toggle or switch the display format to allow display, viewing and editing at least a portion of the document in a full-size display format, e.g., to see what the document looks like on a full-size display. However, at least in some cases, viewing a document in a full-size display format on a small-size display may require more horizontal scrolling, and information may not be as efficiently displayed, e.g., since font sizes may be too large, indents and tabs and margins may be too large relative to the size of the small-size display, sentences may not have been reflowed or wrapped around the short lines of the small-size display, etc.

According to another example embodiment, a small-size display may be a different size than a full-size display. The size of a display may be measured, for example, in pixels for width and height of a display or screen. According to an example embodiment, a one step process or a two step process to reduce an image size for display on a small-size display. For example, many images may be too large to be displayed on a small-size display without scrolling. Therefore, a server 126 may reduce the image so that a width of the image may fit within a longer (or larger) dimension of the small-size display, e.g., for displaying the image on the small-size display in landscape mode. The mobile computing device, after receiving the image, may further reduce the size of the image so that the width of the image may fit within a width of the display (or within the smaller of the two dimensions of the display) if the image is to be displayed in portrait mode, for example.

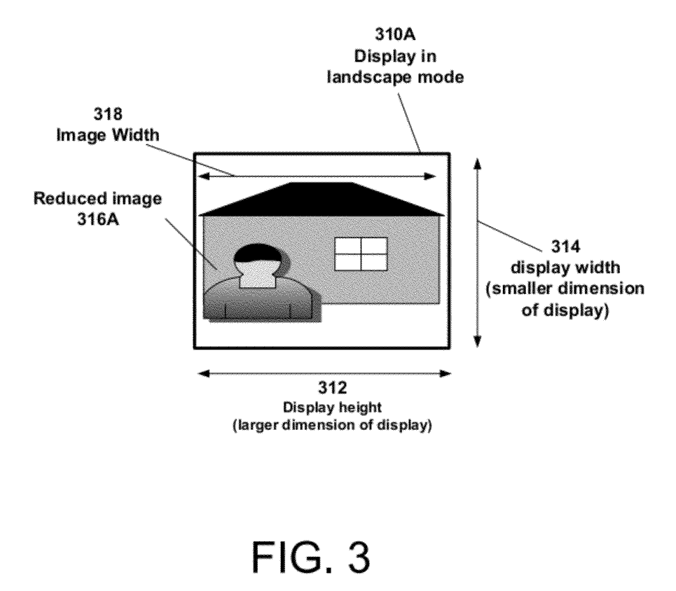

FIG. 3 is a diagram illustrating the reduction of an image size for display on a small-size display according to an example embodiment. A small-size display 310A may be provided that includes two dimensions, including a display height 312 and a display width 314, where the height 312 may be the larger of the two dimensions of the display 310A. Height and width of the display may be measured in inches, pixels or other measurement, for example. Small-size display 310A may be configured to display the image 316A in a landscape mode, for example.

According to an example embodiment, the mobile computing device may send a request for an image (or for a document that includes an image). Server 126 (FIG. 1) may receive the request for the document or image. The server 126 (or other computing device that stores the image) may determine a display size of the requesting device. For example, server 126 may receive a code or identifier in the request that identifies the device type of the requesting mobile computing device, e.g., manufacturer and model number of the cell phone, wireless device, PDA, etc. For example, the document request from the mobile computing device to the server may include a user agent string. The server 126 may perform a lookup in a table (e.g., based on an OS, web browser, and/or device type identified in the document request) to determine a height and width of the small-size display of the requesting device, or may access a website or other server to obtain the size of the display of the requesting device, for example. Alternatively, the server 126 may assume a well-known or average small-size display size. In one example embodiment, a server may categorize the requesting device (e.g., based on the user agent string) as either a computing device having a full-size display (e.g., a full-size device), or a computing device having a small-size display (e.g., a small-size computing device).

The server 126 may then determine whether or not a width of the image is greater than a larger of the two dimensions of the display size of the requesting mobile computing device. If the image width is not greater than the larger dimension of the display, then no image reduction is performed. However, if the image width is greater than a larger (e.g., height) of the display size, then the server 126 may reduce a size of the image so that the width of the image is equal to or less than the larger of these two display size dimensions. The size of the image may be reduced using one or more well known image processing techniques. For example, the image may be reduced using bilinear interpolation or bicubic interpolation. The server 126 may then transmit the image to the requesting mobile computing device. The mobile computing device may receive the requested (reduced) image, and the reduced image 316A may then be displayed on the small-size display 310A in a first mode, e.g., in a landscape mode, where a width 318 of the image 316A is equal to or less than a larger (312) of the two dimensions for the display, for example, as shown in FIG. 3. Thus, the image width 318 may completely fit within the height (or larger dimension) of the display, e.g., when viewing the image in landscape mode, as an example. This may allow a server to resize (or reduce the size) of an object (e.g., image, equation, chart, table) so that the width of the object or image may match (or fit within) the small-size display size or height, e.g., when the cell phone is turned 90 degrees the width of the image fits on the display in landscape mode, for example, as shown in FIG. 3.

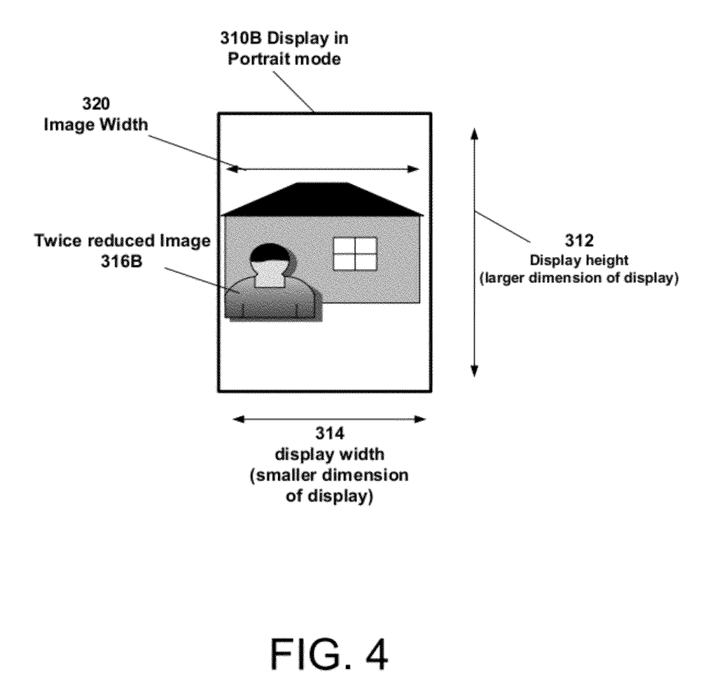

In addition, if the image 316 is to be displayed on the small-size display of the mobile computing device in second mode, e.g., in a portrait mode, the mobile computing device may further reduce the size of the image so that the width of the further reduced image may fit within a smaller of the two dimensions of the display size. FIG. 4 is a diagram illustrating a further reduction in image (or object) size that may be performed by a mobile computing device according to an example embodiment. In an example embodiment, the image 316 is to be displayed on the small-size display 310B in portrait mode. Therefore, after receiving the reduced image, the mobile computing device 120 may further reduce the image size, e.g., using one or more well known image reduction techniques, such as bilinear interpolation or bicubic interpolation, for example, so that a width of the image fits within, or is equal to or less than a smaller (e.g., width 314) of the two dimensions of the display size. The further (or twice) reduced image 316B may then be displayed on the small-size display 310B of the mobile computing device. Thus, according to an example embodiment, a two-step image reduction process may be used, at least in some cases, where a first image reduction may be performed by a server prior to transmitting the image or object to the mobile computing device. A second image reduction may be performed by the mobile computing device if the image needs to be reduced, e.g., to fit within a smaller of the two dimensions of the display size.

This is merely an example, and other variations of a two-step image reduction may be performed, for example, where a server performs a first image reduction, and the mobile computing device performs one or more additional image reduction operations, where these are not limited to reducing the image for landscape or portrait modes, but may include image reductions generally.

According to an example embodiment, in some cases, a computing device may, in effect (or indirectly), identify its display size (or at least identify a display size category, e.g., either full-size display or small-size display) based on information that may be provided by the computing device, e.g., in a user agent string or field. The user agent string may be included, for example, in a header of a document request (such as a HTTP/Hypertext transfer protocol Get request, or other request). For example, a user agent string may include one or more of: an operating system of the requesting computing device; a browser used by the computing device; and/or a device type of the computing device.

The operating system field in a user agent string may identify an operating system or OS that may typically be used by or associated with full-size computing devices or computing devices that may typically have or use a display or screen size (or at least a dimension thereof) greater than a threshold, such as a desktop computer or a laptop computer, as examples. Alternatively, the OS identified by the user agent string may identify an OS typically used by mobile computing devices or small-size computing devices (or devices that may typically have a display or screen size, or a dimension thereof, that is less than a threshold), such as a PDA, cell phone, etc.

The browser field of the user agent string may identify a Web browser used (or typically used) by a full-size computer/computing device (e.g., by a desktop or laptop or the like). Alternatively, the user agent string may identify a Web browser typically used by a mobile computing device, which in some cases, may be referred to as a mobile browser or mini browser, for example.

A user agent string may also include a device type, which may identify the type of device for the computing device, e.g., identifying the type of laptop, desktop, cell phone/smart phone, PDA, etc. The device type portion of a user agent string may identify a full-size computing device or a computing device having (or typically having) a full-size display, such as a specific laptop computer. Alternatively, the device type portion of the user agent string/field may identify a mobile computing device, such as a particular smart phone, PDA or cell phone (e.g., having a small-size display or having a display or dimension thereof that is smaller than a threshold), for example.

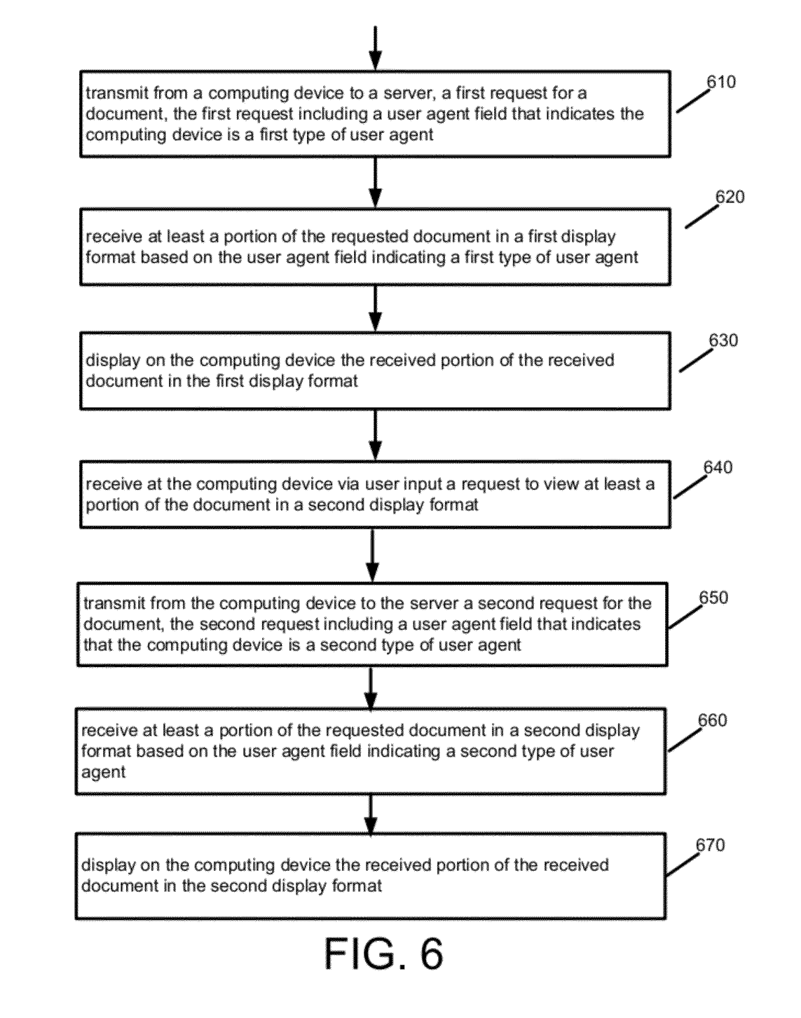

FIG. 6 is a flow chart illustrating operation of a computing device according to an example embodiment. Operation 610 may include transmitting (e.g., from a computing device to a server), a first request (e.g., HTTP Get message) for a document, the first request including a user agent field that indicates the computing device is a first type of user agent. For example, the user agent request may identify a mobile OS, a mobile browser, and/or the device type that identifies the type of mobile computing device, as examples.

Operation 620 may include receiving at least a portion of the requested document in a first display format based on the user agent field indicating a first type of user agent. For example, the mobile computing device may receive a document in a small-size display format (or mobile format), for example. In an example embodiment, the server may serve or transmit the full-size version of the document (e.g., document provided in a full-size display format), or the small-size/mobile version of the document (e.g., document provided in a small-size display format). Each document may include some text or data (e.g., HTML code), and some software code or software instructions (e.g., a Java script embedded in the HTML code), where the software instructions/code may at least identify how the document should be displayed and/or include display format information, for example. Thus, the full-size and small-size/mobile version of a document may include different software or a different Java script, for example.

Operation 630 may include displaying on the computing device the received portion of the received document in the first display format. For example, the mobile computing device (which includes a processor) may receive the document (HTML code and Java script), and may execute the Java script, which may cause the mobile computing device to display the document on its display.

Operation 640 may include receiving at the computing device via user input a request to view at least a portion of the document in a second display format. For example, the user may be viewing the document in a small-size display format. The user may want to view the document in a full-size display format or mode. Thus, at 640, a user control input (e.g., a user pressing or selecting an icon, such as a magnifying glass icon or other control input on the computing device), may request a display of at least a portion of the document in a full-size format.

Operation 650 may include transmitting from the computing device to the server a second request (e.g., a second HTTP Get request) for the document. The second request includes a user agent field that indicates that the computing device is a second type of user agent. In an example embodiment, the server may serve up or provide a document in a small-size display format (or small-size version of the document) if a user agent is specified that corresponds to a mobile computing device (or user agent identifies a mobile computing device having a display e.g., with a dimension that is less than a threshold), and the server may serve or provide the document in a full-size display format (or a full-size version of the document) if a user agent is specified in the Get request that corresponds to a full-size (or non-small-size) display or computing device (e.g., laptop or desktop, or user agent string identifies a device having or typically having a display with a dimension that is greater than a threshold). Thus, in this case, in operation 650, because the user has selected a control button to request a display of the full-size version of the document, the mobile computing device may send an agent string that includes pseudo information, that is, an agent string that specifies an OS, web browser and/or device type that are associated with or that identify a full-size computing device, even though such information in the user agent string does not match the requesting computing device's OS, browser and device type. Thus, for example, because the mobile computing device would like to receive a full-size version of the document, the second Get request (of operation 650) may include an agent string that identifies a full-size OS, a full-size web browser and/or a full-size device type (e.g., desktop or laptop). While the user agent string in the second Get request may technically provide inaccurate information, such a use of the user agent string may be used to obtain a document of a specific format (which may not be the display format for the requesting computing device), without the server being reprogrammed.

Operation 660 may include receiving at least a portion of the requested document in a second display format (e.g., full-size display format) based on the user agent field indicating a second type of user agent (e.g., based on the user agent string identifying a full-size OS, browser or device type). Operation 670 may include displaying on the computing device the received portion of the received document in the second display format.

In an example embodiment, the user agent may identify one or more of the following for the computing device: a operating system used by the computing device; a browser used by the computing device; or a device type for the computing device. In another example embodiment, the first type of user agent may be associated with a computing device having a full-size display with at least one dimension that is greater than a threshold. The second type of user agent is associated with a mobile computing device having a small-size display with at least one dimension that is less than the threshold. In an still another example embodiment, the second display format is a full-size display format, and the first display format is a small-size display format that accommodates a display having a dimension that is smaller than a threshold. In a further example embodiment, the second type of user agent may be associated with a computing device having a full-size display with at least one dimension that is greater than a threshold. The first type of user agent may be associated with a mobile computing device having a small-size display with at least one dimension that is less than the threshold, and the first type of user agent may be associated with a computing device having a display with at least a first dimension that is less than a threshold. The second type of user agent may be associated with a computing device having a display with at least the first dimension that is greater than the threshold. The first display format may be a full-size display format, and the second display format may be a mobile display format.

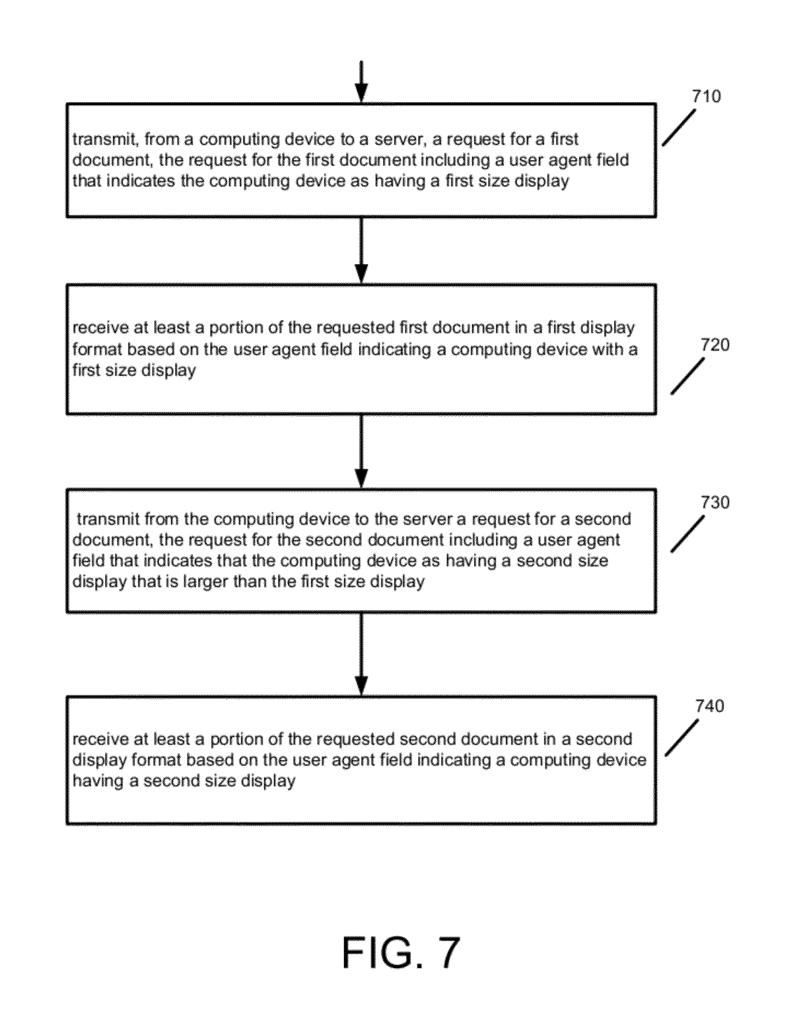

FIG. 7 is a flow chart illustrating operation of a mobile computing device according to an example embodiment. Various operations are shown in the flow chart. Operation 710 may include transmitting, from a computing device (e.g., mobile computing device or other computing device) to a server, a request for a first document. The request for the first document may include a user agent field that indicates the mobile computing device as having a first size display. Operation 720 may include receiving at least a portion of the requested first document in a first (e.g., small-size) display format based on the user agent field indicating the computing device with a first size display (e.g., indicating a mobile computing device or a computing device having a small-size display). Operation 730 may include transmitting from the computing device to the server a request for a second document, the request for the second document including a user agent field that indicates a computing device having a second size (e.g., fullsize) display that is larger than the first size (e.g., small-size) display. Operation 740 may include receiving at least a portion of the requested second document in a second (e.g., full-size) display format based on the user agent field indicating a computing device having a second size (e.g., full-size) display. The first and second documents may be the same document, but in different formats. Alternatively, the first and second documents may be different documents, also provided in different formats.

In the example method of FIG. 7, the first size display may include a display having a dimension that is less than a threshold (e.g., a small-size display), and the second size display may include a display having a dimension that is greater than the threshold (e.g., a full-size display). The first display format is a small-size display format and the second display format is a full-size display format. The method illustrated in FIG. 7 may further include displaying on the computing device (e.g., mobile computing device) at least one of a portion of the requested first document in a first (e.g., small-size) display format or a portion of the requested second document in a second (e.g., full-size) display format. In an example embodiment, the first document and the second document may include a same data, wherein the first document provides the data in a first (e.g., small-size or full-size) display format and the second document provides the data in a second (e.g., full-size or small-size) display format. In an example embodiment, the user agent may identify one or more of the following for a computing device: an operating system used by the computing device, a browser used by the computing device, or a device type for the computing device.

According to an example embodiment, an apparatus may include a processor and a memory that includes computer program code. The memory and the computer program code are configured to, along with the processor, cause the apparatus to receive, by a computing device (e.g., mobile computing device) having a display with a first dimension that is less than a threshold size, a document that includes text and at least one image. The apparatus is further caused to reformat the document for display on the computing device. The reformatting may include decreasing a size for at least one of tabs or indents, and moving a location of the at least one image to the left on the display of the mobile computing device. As noted above, moving an image to the left may include, for example, left justifying the image, or decreasing a space between a left margin and a left edge of the image.

In an example embodiment, the processor may further cause the apparatus to limit a font size for the text of the document to a maximum font size. The apparatus may be caused to: determine a maximum font size to be used for displaying the document text on the computing device, identify any text in the document that has a font size that is greater than the maximum font size; and decrease the font size of the identified text to the maximum font size. In an example embodiment, the processor may further cause the apparatus to decrease margins in the document.

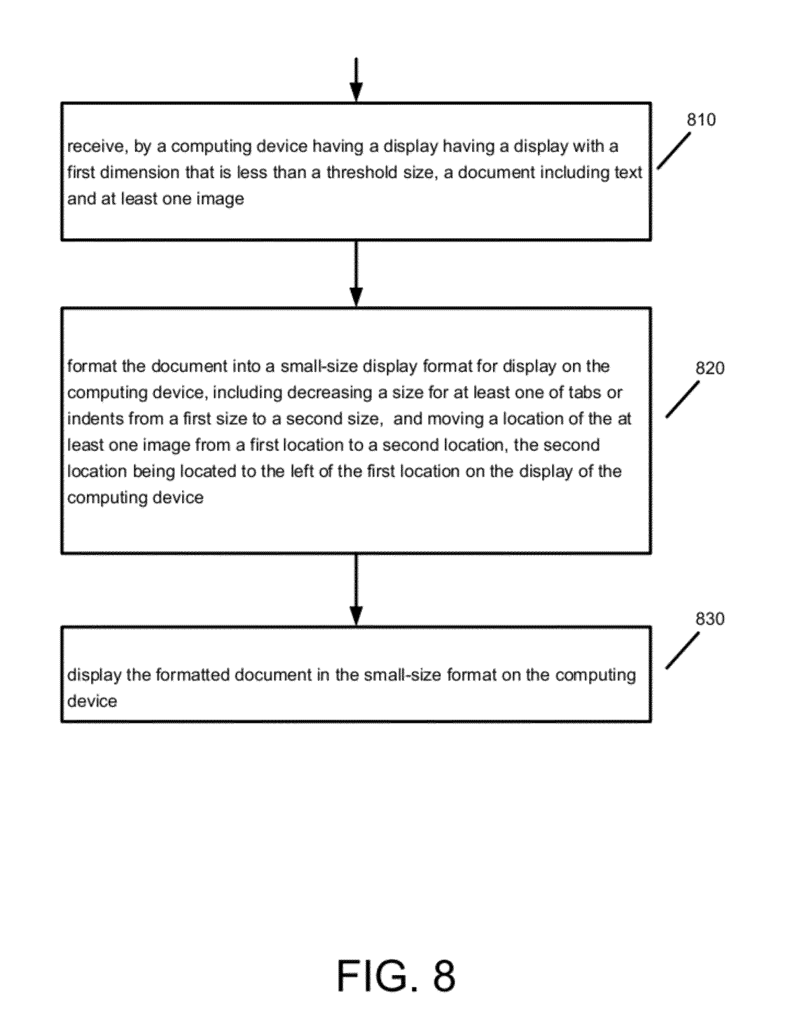

FIG. 8 is a flow chart illustrating operation of a computing device according to an example embodiment, in which various operations are shown. Operation 810 may include receiving, by a computing device (e.g., mobile computing device) having a display having a display with a first dimension that is less than a threshold size, a document including text and at least one image. Operation 820 may include formatting the document into a small-size display format for display on the computing device. The reformatting may include decreasing a size for at least one of tabs or indents from a first size to a second size, and moving a location of the at least one image from a first location to a second location. The second location may be located to the left of the first location on the display of the computing device. Operation 830 may include displaying the formatted document in the small-size format on the mobile computing device.

In an example embodiment, the formatting the document into a small-size display format may further include limiting a font size for the text of the document to a maximum font size. In an example embodiment, the limiting a font size may include: determining a maximum font size to be used for displaying the document text on the computing device, identifying any text in the document that has a font size that is greater than the maximum font size, and decreasing the font size of the identified text to the maximum font size. In an example embodiment, the formatting the document for display on the computing device may further include decreasing margins, removing at least one of indents or tabs for the document and wrapping text at the border of the display of the computing device to a next line of the display.

The method illustrated in FIG. 8 may further include replacing one or more embedded objects in the document with an icon. The method of FIG. 8 may further include receiving at the computing device a user request to display at least a portion of the document in a full-size display format, reformatting at least a portion of the document from the small-size format to the full-size format, and displaying on the computing device the reformatted portion of the document in the full-size format in response to the user request. In an example embodiment, the reformatting at least a portion of the document from the small-size format to the full-size format may include at least increasing a size for at least one of tabs or indents from the second size to the first size and moving a location of the at least one image from the second location to the first location.

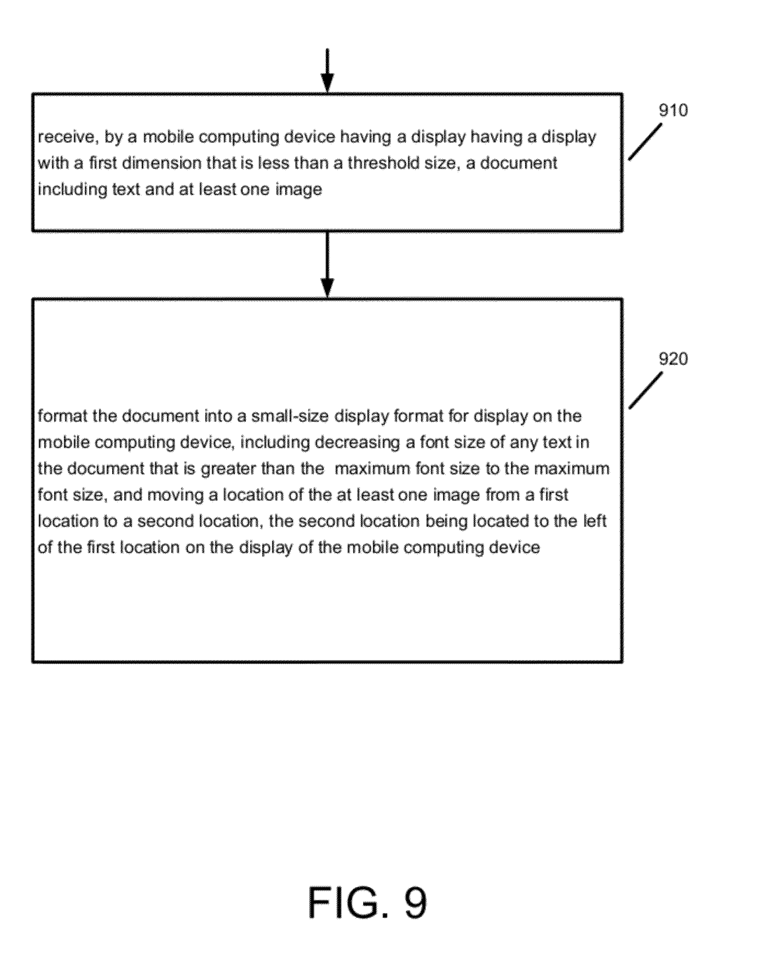

FIG. 9 is a flow chart illustrating operation of a computing device according to an example embodiment, in which various operations are shown. Operation 910 may include receiving, by a computing device having a display having a display with a first dimension that is less than a threshold size, a document including text and at least one image. Operation 920 may include formatting the document into a small-size display format for display on the computing device, including decreasing a font size of any text in the document that is greater than the maximum font size to the maximum font size and moving a location of the at least one image from a first location to a second location, the second location being located to the left of the first location on the display of the computing device. In an example embodiment, the computing device may include a mobile computing device, wherein the received document (as received) may be formatted for display on a device having a display that is larger than the display of the mobile computing device. The method may further include decreasing a size for at least one of tabs or indents.

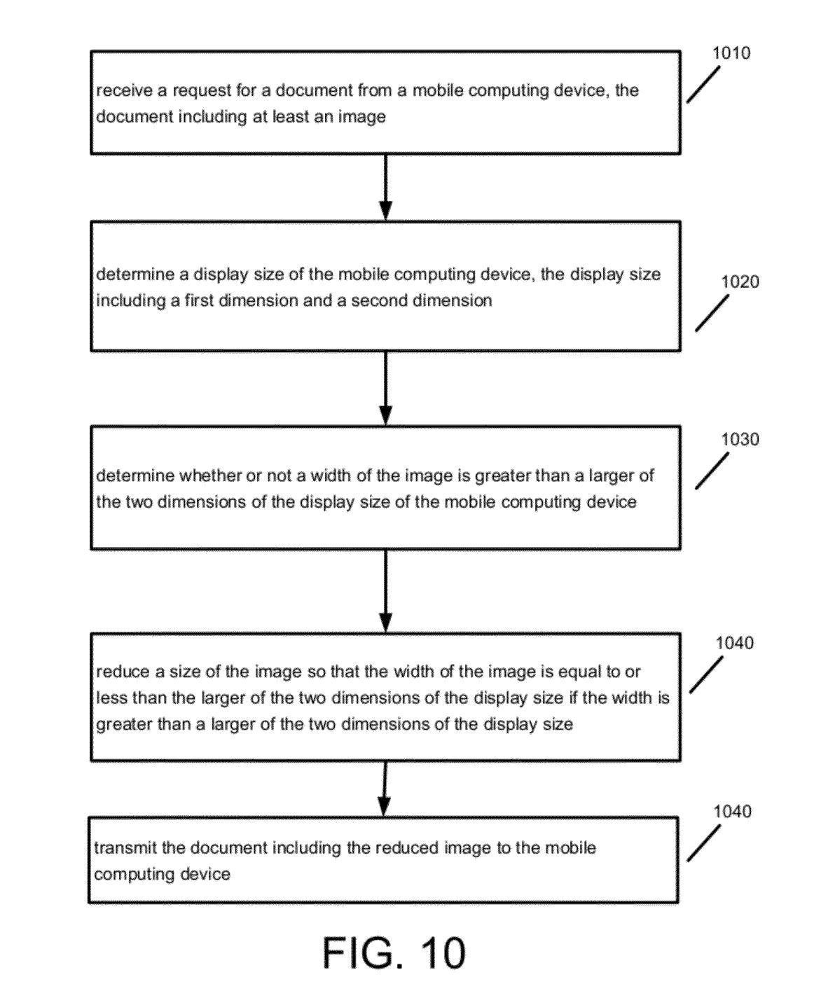

FIG. 10 is a flow chart illustrating operation according to an example embodiment, in which various operations are shown. Operation 1010 may include receiving a request for a document from a mobile computing device, the document including at least an image. Operation 1020 may include determining a display size of the mobile computing device. The display size may include a first dimension and a second dimension. Operation 1030 may include determining whether or not a width of the image is greater than a larger of the two dimensions of the display size of the mobile computing device. Operation 1040 may include reducing a size of the image so that the width of the image is equal to or less than the larger of the two dimensions of the display size if the width is greater than a larger of the two dimensions of the display size. Operation 1050 may include transmitting the document including the reduced image to the mobile computing device.

In an example embodiment, the request may include a user agent field that identifies one or more of the following for the mobile computing device: an operating system used by the mobile computing device, a browser used by the mobile computing device, or a device type for the mobile computing device. The determining a display size of the mobile computing device may include performing a lookup into a table of display sizes based on the received user agent field to determine the display size of the mobile computing device. The method of FIG. 10 may further include receiving the document including the reduced image, and displaying the reduced image on the display of mobile computing device in a first display mode. The method may further include performing the following in a second display mode: further reducing a size of the image so that a width of the image is equal to or less than a smaller of the two dimensions of the display size of the mobile computing device and displaying the further reduced image on the display of the mobile computing device in the second display mode. In an example embodiment, the two dimensions of the display may be height and width, and wherein a first display mode is landscape mode and a second display mode is portrait mode.

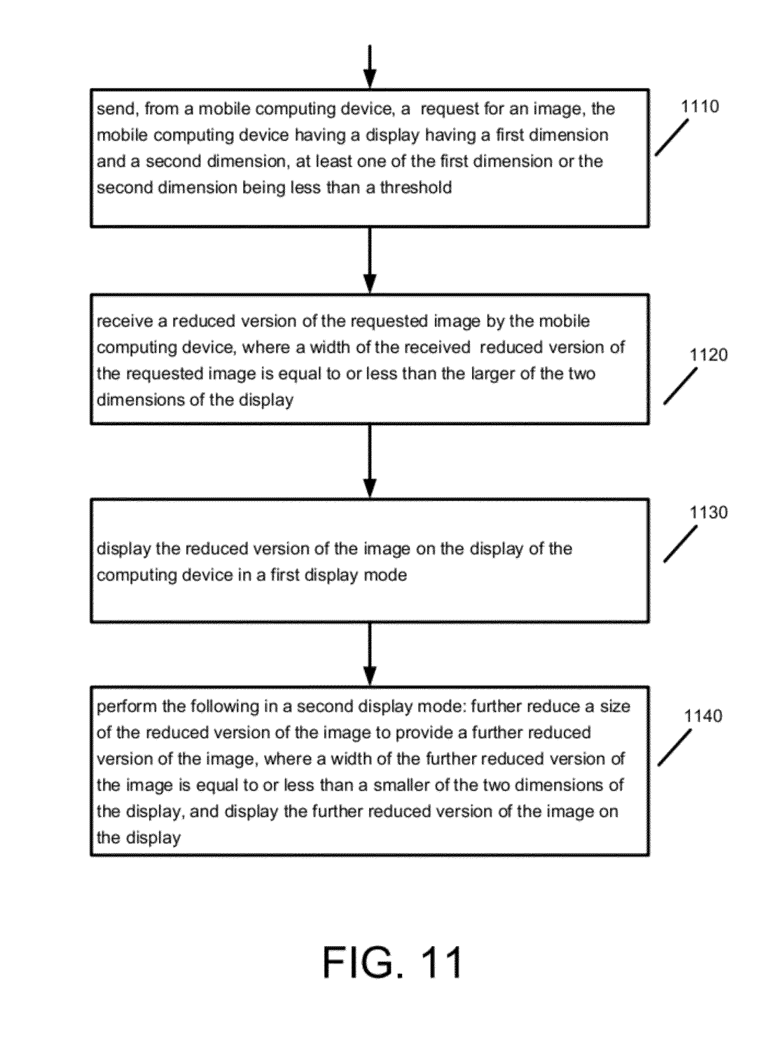

FIG. 11 is a flow chart illustrating operation according to an example embodiment, in which various operations are shown. Operation 1110 may include sending, from a mobile computing device, a request for an image, the mobile computing device having a display having a first dimension and a second dimension. At least one of the first dimension or the second dimension is less than a threshold. Operation 1120 may include receiving a reduced version of the requested image by the mobile computing device. A width of the received reduced version of the requested image is equal to or less than the larger of the two dimensions of the display. Operation 1130 may include displaying the reduced version of the image on the display of the computing device in a first display mode. Operation 1140 may include performing the following in a second display mode: further reducing a size of the reduced version of the image to provide a further reduced version of the image. A width of the further reduced version of the image is equal to or less than a smaller of the two dimensions of the display. Operation 1140 may also include displaying the further reduced version of the image on the display. In an example embodiment, the method may further include receiving by the mobile computing device a display mode selection (e.g., via user input by mouse, touchscreen, pointing device or other input device) wherein either the landscape mode or the portrait mode is selected.

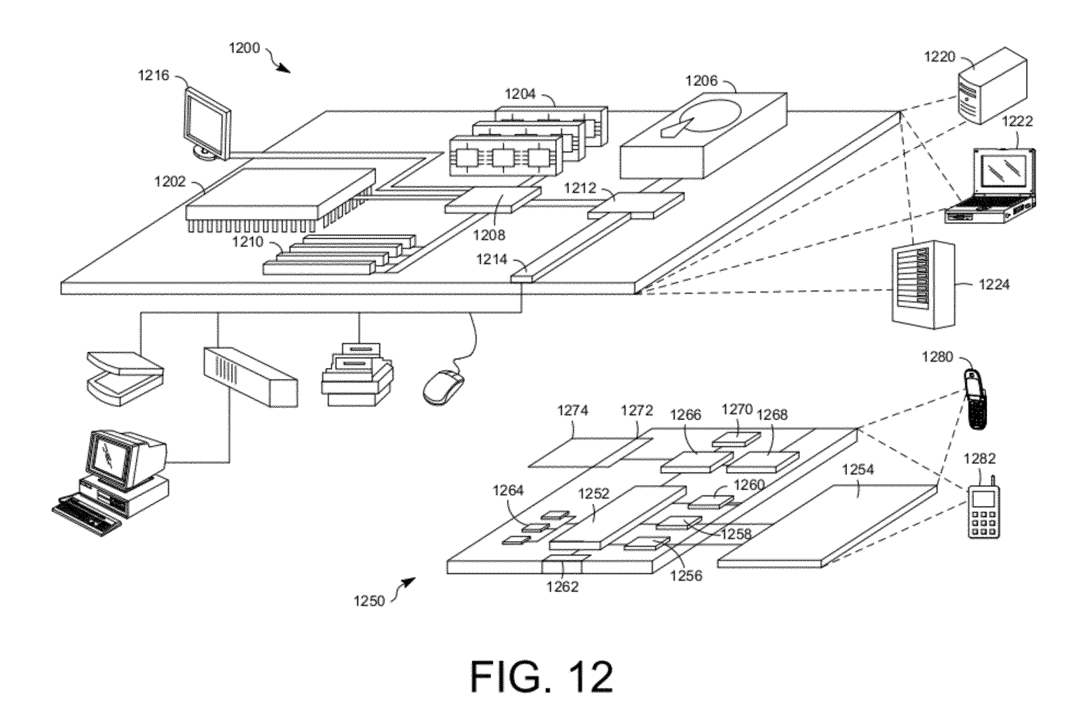

FIG. 12 is a block diagram showing example or representative structure, devices and associated elements that may be used to implement the computing devices and systems described herein, e.g., for desktop/laptop computing device 110 and mobile computing device 120. FIG. 12 shows an example of a generic computing device 1200 and a generic mobile computing device 1250, which may be used with the techniques described here. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk. The storage device 1206 is capable of providing mass storage for the computing device 1200. In one implementation, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, or memory on processor 1202.

The high speed controller 1208 manages bandwidth-intensive operations for the computing device 1200, while the low speed controller 1212 manages lower bandwidth-intensive operations. Such allocation of functions is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display (or screen) 1254 may be, for example, a TFT LCD (Thin-Film-Transistor Liquid Crystal Display) or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provide in communication with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provide as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252, that may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning system) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in the figure. For example, it may be implemented as a cellular telephone 1280. It may also be implemented as part of a smart phone 1282, personal digital assistant, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

What is claimed is:

1. An apparatus comprising:
at least one processor;
at least one memory including computer program code, the at least one memory and the computer program code configured to, with the at least one processor, cause the apparatus to at least:
receive, by a computing device having a display with a first dimension that is less than a threshold, a document including text and at least one image;
reformat the document for display on the computing device, including:
decreasing a size for at least one of tabs or indents; and
moving a location of the at least one image to the left on the display of the computing device.

2. The apparatus of claim 1 wherein the computing device comprises a mobile computing device.

3. The apparatus of claim 1, wherein the memory and the computer program code configured, along with the processor, are further configured to cause the apparatus to limit a font size for the text of the document to a maximum font size.

4. The apparatus of claim 2, wherein the memory and the computer program code configured, along with the processor, are further configured to cause the apparatus to:
determine a maximum font size to be used for displaying the document text on the mobile computing device;
identify any text in the document that has a font size that is greater than the maximum font size; and
decrease the font size of the identified text to the maximum font size.

5. The apparatus of claim 1, wherein the memory and the computer program code configured, along with the processor, are further configured to cause the apparatus to decrease margins in the document.

6. A method comprising:
receiving, by a computing device having a display with a first dimension that is less than a threshold, a document including text and at least one image;
formatting the document into a small-size display format for display on the computing device, including:
decreasing a size for at least one of tabs or indents from a first size to a second size; and
moving a location of the at least one image from a first location to a second location, the second location being located to the left of the first location on the display of the computing device; and displaying the formatted document in the small-size format on the computing device.

7. The method of claim 6 wherein the computing device comprises a mobile computing device, and wherein the received document is formatted for display on a device having a display that is larger than the display of the computing device.

8. The method of claim 6 wherein the moving comprises performing at least one of the following: left justifying the image, or decreasing a distance between a left margin of the document and a left edge of the image to move the image closer to the left margin.

9. The method of claim 6 wherein the formatting the document into a small-size display format further comprises limiting a font size for the text of the document to a maximum font size.

10. The method of claim 9 wherein the limiting a font size comprises:
determining a maximum font size to be used for displaying the document text on the computing device;
identifying any text in the document that has a font size that is greater than the maximum font size; and
decreasing the font size of the identified text to the maximum font size.

11. The method of claim 6 wherein the formatting the document for display on the computing device further comprises:
decreasing margins;
removing at least one of indents or tabs for the document; and
wrapping text at the border of the display of the mobile computing device to a next line of the display.

12. The method of claim 6 and further comprising:
replacing one or more embedded objects in the document with an icon.

13. The method of claim 6 and further comprising:
receiving at the computing device a user request to display at least a portion of the document in a full-size display format;
reformatting at least a portion of the document from the small-size format to the full-size format; and
displaying on the computing device the reformatted portion of the document in the full-size format in response to the user request.

14. The method of claim 13 wherein the reformatting at least a portion of the document from the small-size format to the full-size format comprises at least:
increasing a size for at least one of tabs or indents from the second size to the first size; and
moving a location of the at least one image from the second location to the first location.

15. A method comprising:
receiving, by a computing device having a display with a first dimension that is less than a threshold size, a document including text and at least one image;
formatting the document into a small-size display format for display on the computing device, including:
decreasing a font size of any text in the document that is greater than the maximum font size to the maximum font size; and
moving a location of the at least one image from a first location to a second location, the second location being located to the left of the first location on the display of the computing device.

16. The method of claim 15 wherein the computing device comprises a mobile computing device, and wherein the received document is formatted for display on a device having a display that is larger than the display of the computing device.

17. The method of claim 15 wherein the decreasing a font size comprises:
determining a maximum font size to be used for displaying the document text on the computing device;
identifying any text in the document that has a font size that is greater than the maximum font size; and
decreasing the font size of the identified text to the maximum font size.

18. The method of claim 15 and further comprising decreasing a size for at least one of tabs or indents.

19. A method comprising:
transmitting, from a computing device to a server, a first request for a document, the first request including a user agent field that indicates the computing device is a first type of user agent;
receiving at least a portion of the requested document in a first display format based on the user agent field indicating a first type of user agent;
displaying, on the computing device, the received portion of the received document in the first display format;
receiving, at the computing device, via user input a request to view at least a portion of the document in a second display format;
transmitting, from the computing device to the server, a second request for the document, the second request including a user agent field that indicates that the computing device is a second type of user agent;
receiving at least a portion of the requested document in a second display format based on the user agent field indicating a second type of user agent; and
displaying on the computing device the received portion of the received document in the second display format.

20. The method of claim 19 wherein the user agent identifies one or more of the following for the computing device:
an operating system used by the computing device;
a browser used by the computing device; or
a device type for the computing device.

21. The method of claim 19 wherein the first type of user agent is associated with a computing device having a full-size display with at least one dimension that is greater than a threshold, and wherein the second type of user agent is associated with a mobile computing device having a small-size display with at least one dimension that is less than the threshold.

22. The method of claim 19 wherein the second display format is a full-size display format, and the first display format is a small-size display format that accommodates a display having a dimension that is smaller than a threshold.

23. The method of claim 19 wherein the second type of user agent is associated with a computing device having a full-size display with at least one dimension that is greater than a threshold, and wherein the first type of user agent is associated with a mobile computing device having a small-size display with at least one dimension that is less than the threshold.

24. The method of claim 19 wherein the first type of user agent is associated with a computing device having a display with at least a first dimension that is less than a threshold, and the second type of user agent is associated with a computing device having a display with at least the first dimension that is greater than the threshold.

25. The method of claim 24 wherein the first display format is a full-size display format, and the second display format is a mobile display format.

26. An apparatus comprising:
at least one processor;
at least one memory including computer program code, the at least one memory and the computer program code configured to, with the at least one processor cause the apparatus to at least:
transmit, from a computing device to a server, a first request for a document, the first request including a user agent field that indicates the computing device is a first type of user agent;
receive at least a portion of the requested document in a first display format based on the user agent field indicating a first type of user agent;
display, on the computing device, the received portion of the received document in the first display format;
receive, at the computing device, via user input a request to view at least a portion of the document in a second display format;
transmit, from the computing device to the server, a second request for the document, the second request including a user agent field that indicates that the computing device is a second type of user agent;
receive at least a portion of the requested document in a second display format based on the user agent field indicating a second type of user agent; and
display on the computing device the received portion of the received document in the second display format.

27. A method comprising:
transmitting, from a computing device to a server, a request for a first document, the request for the first document including a user agent field that indicates the computing device as having a first size display;
receiving at least a portion of the requested first document in a first display format based on the user agent field indicating a computing device with a first size display;
transmitting from the computing device to the server a request for a second document, the request for the second document including a user agent field that indicates the computing device as having a second display that is larger than the first size display; and
receiving at least a portion of the requested second document in a second display format based on the user agent field indicating a computing device having a second size display.

28. The method of claim 27 wherein the first size display comprises a display having a dimension that is less than a threshold, and wherein the second size display comprises a display having a dimension that is greater than the threshold, and wherein the first display format is a small-size display format and the second display format is a full-size display format.

29. The method of claim 28 and further comprising displaying on the computing device at least one of a portion of the requested first document in a small-size display format or a portion of the requested second document in a full-size display format.

30. The method of claim 28 wherein the first document and the second document include a same data, wherein the first document provides the data in a small-size display format and the second document provides the data in a full-size display format.

31. The method of claim 28 wherein the user agent identifies one or more of the following for a computing device:
an operating system used by the computing device;
a browser used by the computing device; or
a device type for the computing device.

32. An apparatus comprising:
at least one processor;
at least one memory including computer program code, the at least one memory and the computer program code configured to, with the at least one processor cause the apparatus to at least:
transmit, from a computing device to a server, a request for a first document, the request for the first document including a user agent field that indicates the computing device as having a first size display;
receive at least a portion of the requested first document in a first display format based on the user agent field indicating a computing device with a first size display;
transmit from the computing device to the server a request for a second document, the request for the second document including a user agent field that indicates the computing device as having a second display that is larger than the first size display; and
receive at least a portion of the requested second document in a second display format based on the user agent field indicating a computing device having a second size display.

33. A method comprising:
receiving a request for a document from a mobile computing device, the document including at least an image;
determining a display size of the mobile computing device, the display size including a first dimension and a second dimension;
determining whether or not a width of the image is greater than a larger of the two dimensions of the display size of the mobile computing device;
reducing a size of the image so that the width of the image is equal to or less than the larger of the two dimensions of the display size if the width is greater than a larger of the two dimensions of the display size; and
transmitting the document including the reduced image to the mobile computing device.

34. The method of claim 33 wherein the request includes a user agent field that identifies one or more of the following for the mobile computing device:
an operating system used by the mobile computing device;
a browser used by the mobile computing device; or
a device type for the mobile computing device;
and wherein the determining a display size of the mobile computing device comprises performing a lookup into a table of display sizes based on the received user agent field to determine the display size of the mobile computing device.

35. The method of claim 33 and further comprising:
receiving the document including the reduced image;
displaying the reduced image on the display of mobile computing device in a first display mode;
performing the following in a second display mode:
further reducing a size of the image so that a width of the image is equal to or less than a smaller of the two dimensions of the display size of the mobile computing device;
displaying the further reduced image on the display of the mobile computing device in the second display mode.

36. The method of claim 35 wherein the two dimensions of the display are height and width, and wherein a first display mode is landscape mode and a second display mode is portrait mode.

37. An apparatus comprising:
at least one processor;
at least one memory including computer program code, the at least one memory and the computer program code configured to, with the at least one processor cause the apparatus to at least:
receive a request for a document from a mobile computing device, the document including at least an image;
determine a display size of the mobile computing device, the display size including a first dimension and a second dimension;
determine whether or not a width of the image is greater than a larger of the two dimensions of the display size of the mobile computing device;
reduce a size of the image so that the width of the image is equal to or less than the larger of the two dimensions of the display size if the width is greater than a larger of the two dimensions of the display size; and
transmit the document including the reduced image to the mobile computing device.

38. The apparatus of claim 37 with the at least one processor being further configured to cause the apparatus to at least:
receive the document including the reduced image;
display the reduced image on the display of mobile computing device in a first display mode; and
perform the following in a second display mode:
further reduce a size of the image so that a width of the image is equal to or less than a smaller of the two dimensions of the display size of the mobile computing device; and
display the further reduced image on the display of the mobile computing device in the second display mode.

39. A method comprising:
sending, from a computing device, a request for an image, the computing device having a display having a first dimension and a second dimension, at least one of the first dimension or the second dimension being less than a threshold dimension;
receiving a reduced version of the requested image by the computing device, wherein a width of the received reduced version of the requested image is equal to or less than the larger of the two dimensions of the display;
displaying the reduced version of the image on the display of the computing device in a first display mode;
performing the following in a second display mode:
further reducing a size of the reduced version of the image to provide a further reduced version of the image, wherein a width of the further reduced version of the image is equal to or less than a smaller of the two dimensions of the display; and
displaying the further reduced version of the image on the display.

40. The method of claim 39 wherein the first display mode is landscape mode, and the second display mode is portrait mode.

41. The method of claim 39, wherein the computing device is a mobile computing device, the method further comprising receiving by the mobile computing device a display mode selection wherein either the landscape mode or the portrait mode is selected.

42. A computer program product tangibly embodied on a computer-readable medium and including executable code that, when executed, is configured to cause one or more processors of a computing device to:
send, from the computing device, a request for an image, wherein the computing device includes a display having a first dimension and a second dimension, at least one of the first dimension or the second dimension being less than a threshold;
receive a reduced version of the requested image at the computing device, wherein a width of the received reduced version of the requested image is equal to or less than the larger of the two dimensions of the display;
display the reduced version of the image on the display of the computing device in a first display mode; and
perform the following in a second display mode:
further reduce a size of the reduced version of the image to provide a further reduced version of the image, wherein a width of the further reduced version of the image is equal to or less than a smaller of the two dimensions of the display; and
display the further reduced version of the image on the display.
